(19) United States
(12) Patent Application Publication
(10) Pub. No.: US 2026/0308060 A1
(43) Pub. Date: Oct. 8, 2026

(54) METHOD FOR PRODUCING GEOPOLYMER CONCRETE FROM NATURAL SAND COMBINED WITH RED MUD

(71) Applicant: ProtectGD LLC, Bellevue, NE (US)

(72) Inventors: Hau Trung Tran, Bellevue, NE (US); Nghia Trung TRUNG Tran, HCMC (VN)

(21) Appl. No.: 19/171,196

(22) Filed: Apr. 5, 2025

(51) Int. Cl. C04B 28/00; C04B 14/04; C04B 14/06; C04B 14/36; C04B 22/06; C04B 40/00; C04B 103/00; C04B 111/00

(52) U.S. Cl. CPC C04B 28/006; C04B 14/047; C04B 14/048; C04B 14/068; C04B 14/368; C04B 22/062; C04B 40/0039; C04B 40/0082; C04B 2103/0078; C04B 2111/00862

(57) ABSTRACT

A method for producing geopolymer concrete using finely ground natural sand (including desert, sea, river, and mined sand) combined with red mud as the primary alumina source. The method involves mixing SiO₂-rich sand and Al₂O₃-rich red mud, with optional alkaline activators (NaOH, KOH, sodium silicate), followed by shaping via casting, pressing, or extrusion, and thermal curing at 60 °C to 250 °C. This geopolymer concrete exhibits high compressive strength, durability in harsh environments, radiation shielding (when BaSO₄ is added), and low carbon emissions. Optional materials include finely crushed stone, bauxite ore, zeolite for CO₂ absorption, and metakaolin, offering enhanced performance and environmental benefits.

### FIELD OF THE INVENTION

The present invention relates to the field of construction materials, specifically the technology for producing sustainable geopolymer concrete using natural sand and red mud combined with an alkaline activator. Additionally, this invention allows for the flexible application of finely crushed stone as a substitute for sand, high-amorphous silica sand, and finely ground bauxite ore as a replacement for red mud, expanding the scope of applications while maintaining high performance.

This method effectively utilizes abundant but underutilized resources such as desert sand, sea sand, river sand, and mined sand while recycling red mud—a byproduct of alumina production. When finely ground, these sands exhibit high silica (SiO₂) content, whereas red mud contains aluminum oxide (Al₂O₃). When activated by an alkaline solution (NaOH, KOH, Na₂SiO₃), the geopolymerization reaction occurs, forming a robust Si-O-Al network that provides superior properties, including:

High compressive strength, equivalent to or exceeding traditional Portland cement concrete.

Excellent impermeability and chemical corrosion resistance, making it suitable for marine and industrial applications.

High thermal and fire resistance, enhancing structural fire safety.

Low CO₂ emissions, contributing to green construction and sustainable development.

Versatility in raw materials, allowing adaptation to various sands, finely crushed stone, and ores globally.

This invention not only optimizes the use of natural resources but also minimizes environmental impact, particularly in the construction industry and industrial waste management.

### Optimized Manufacturing Process

The manufacturing process can be optimized to maximize the potential of natural sand (desert sand, sea sand, river sand, mined sand), finely crushed stone, and bauxite ore by fine grinding the sand or stone to a particle size of less than 200 microns. This increases the surface area available for reaction with the alkaline activator, thereby producing geopolymer concrete with high mechanical strength, excellent impermeability, and resistance to harsh environmental conditions.

The production process includes various forming techniques such as casting, centrifugal molding, pressure molding, extrusion, rolling, vibration, or vibro-compaction to create dense concrete structures. Additionally, thermal curing is applied to accelerate the geopolymerization reaction, enabling the product to achieve optimal strength within a short period.

### CO₂ Absorption and Environmental Benefits

Notably, geopolymer concrete made from finely ground sand, crushed stone, high-amorphous silica sand, and red mud or bauxite ore exhibits effective CO₂ absorption and storage capabilities, contributing to the reduction of greenhouse gases. The CO₂ absorption process not only mitigates climate impact but also enhances mechanical strength, increases compressive strength, and extends the lifespan of concrete components.

By utilizing red mud or finely ground bauxite ore, both of which are rich in Al₂O₃, this invention not only makes use of readily available resources but also contributes to the circular economy, reducing reliance on Portland cement, minimizing river sand extraction, and providing significant economic benefits.

Additionally, the incorporation of Barium Sulfate (BaSO₄) in concentrations up to 15% enhances radiation shielding capabilities, opening potential applications in nuclear laboratories, hospitals, and heavy industrial facilities.

With these characteristics, this invention represents a breakthrough in construction materials, advancing sustainable building practices, reducing emissions, and offering versatile applications across various construction sectors.

### BACKGROUND OF THE INVENTION

Currently, red mud—a solid waste byproduct from alumina production—is primarily stored in reservoirs or disposal sites, posing severe environmental issues such as soil and water pollution and the risk of red mud landslides. Managing red mud presents numerous challenges due to its high alkalinity, difficulty in processing, and the large land area required for long-term storage. This not only harms the environment but also incurs significant maintenance and disposal costs for the metallurgical industry.

Additionally, desert sand and certain other types of natural sand (sea sand, river sand, and mined sand) have not been effectively utilized in construction due to their physical and chemical characteristics:

Desert sand: Consists of rounded, smooth particles that exhibit poor bonding characteristics with Portland cement.

Sea sand: High salt content, which may cause reinforcement corrosion.

Mined sand and river sand: Fine-grained particles that affect the density and durability of traditional concrete.

Meanwhile, the global construction industry faces a growing scarcity of construction-grade sand, leading to excessive mining that results in adverse effects such as riverbank erosion, loss of arable land, and disruption of aquatic ecosystems.

Furthermore, traditional concrete using Portland cement is one of the largest sources of CO₂ emissions worldwide, accounting for approximately 8% of global CO₂ emissions. The production process of cement is not only energy-intensive but also has a significant environmental impact. Additionally, Portland cement concrete lacks durability in marine environments due to chloride and sulfate ion corrosion, leading to shortened structure lifespan and high maintenance costs.

In this context, the development of sustainable and environmentally friendly alternative materials such as geopolymer concrete has become urgent. Although significant research has been conducted on geopolymer concrete, most studies have focused on using fly ash as the primary raw material, while the potential of natural sands combined with red mud—two abundant global resources—has not been fully exploited.

The present invention leverages the high silica (SiO₂) content of sand combined with the high alumina (Al₂O₃) content of red mud in an optimized ratio to produce geopolymer concrete with superior properties, addressing sand mining challenges, industrial waste management, and CO₂ emission reduction simultaneously.

### SUMMARY OF THE INVENTION

The invention provides a novel method to produce geopolymer concrete using finely ground sand (≤200 μm) and red mud activated by alkaline solutions. Optional materials include bauxite ore or metakaolin (as Al₂O₃ sources), crushed stone (as sand substitute), zeolite (for CO₂ capture), and barium sulfate (for radiation shielding).

The process includes:

In one embodiment, the invention provides a method for producing geopolymer concrete using natural sand (including desert sand, sea sand, river sand, or mined sand) and red mud. The raw materials comprise finely ground natural sand with a particle size of 200 microns or less (in the range of 50% to 95% by weight), red mud (5% to 50% by weight), and water (5% to 30% by weight).

An alkaline activator may be optionally included only when the alkalinity of the red mud is insufficient to initiate geopolymerization. The alkaline activator can include NaOH, KOH, Na₂SiO₃, K₂SiO₃, Ca(OH)₂, liquid glass, or combinations thereof, in a range from 0% to 20% by weight.

If used, the alkaline activator is first dissolved in water to form an activation solution, then thoroughly mixed with the sand and red mud to form a geopolymer mortar.

The mortar may be shaped into desired forms using techniques such as casting, hydraulic pressing, extrusion, rolling, centrifugal casting, vibration, or vibro-compaction. The shaped product is then hardened by drying at temperatures ranging from 60 °C to 250 °C

In some embodiments, the water content may be increased up to 60% for conventional casting. After setting and demolding, the product undergoes staged heating including: (a) pre-heating at 80 °C to reduce moisture below 30%, and (b) further heating up to 250 °C to complete the geopolymerization.

When the natural sand used contains high levels of amorphous silica, the grinding step may be omitted.

Finely ground sand can also be substituted with finely crushed stone, or combined with aggregates rich in SiO₂ such as crushed stone, gravel, fly ash, metakaolin, silica fume, diatomite, rice husk ash, glass powder, or recycled materials.

Red mud may be replaced with finely ground bauxite ore or metakaolin to provide the necessary Al₂O₃ for the geopolymerization reaction.

To optimize processing, the mortar may be preheated at 60 °C to 150 °C before shaping, or granulated into pellets for easier feeding into forming equipment.

The drying process can be carried out using different methods including resistive heating, gas-fired ovens, infrared heating, vacuum drying, autoclave curing, convection heating, solar drying, or microwave drying.

In certain applications, steel reinforcement may be embedded to produce reinforced geopolymer concrete similar to conventional reinforced concrete.

Additives such as plasticizers, waterproofing agents, strength enhancers, and fibers may be included to improve mechanical performance.

Zeolite may be incorporated up to 20% by weight to enhance mechanical properties and carbon dioxide absorption.

In specific applications, up to 15% by weight of barium sulfate (BaSO₄) may be added to improve radiation shielding, making the material suitable for nuclear or medical environments.

The final product of the method described may be used as a sustainable substitute for conventional Portland cement-based concrete in a variety of structural and non-structural applications.

### DETAILED DESCRIPTION OF THE INVENTION

### 1. Method for Producing Geopolymer Concrete from Finely Ground Sand and Red Mud

### (i) Raw Material Preparation

The primary raw materials for producing geopolymer concrete in this invention include:

Finely Ground Sand:
The sand used in this method can come from natural sources, including desert sand, sea sand, river sand, mined sand, or artificial sand from crushed rock.
The sand is ground to a particle size of less than 200 microns to increase surface area exposure, optimizing the geopolymerization reaction.
The content of finely ground sand ranges from 50% to 95% by weight of the total solid mixture.

Red Mud:
Red mud is a waste byproduct from the alumina production process (bauxite ore refining).
The main composition of red mud includes Al₂O₃, Fe₂O₃, SiO₂, and Na₂°, with a high alkaline nature.
Red mud is dried and finely ground to enhance reactivity.
The content of red mud in the geopolymer mixture ranges from 5% to 50% by weight.

Alkaline Activator:
NaOH, KOH, Na₂SiO₃, K₂SiO₃, Ca(OH)₂, or their mixtures can be used as alkaline activators to initiate the geopolymerization reaction.
The amount of the alkaline activator may range from 0% to 20% by weight.
In some cases, no additional alkaline activator is required if the red mud contains sufficient residual alkalinity to trigger geopolymerization.

Water:
Water is used to dissolve the alkaline activator and provide moisture necessary for the reaction.
The water content ranges from 5% to 30% by weight of the total geopolymer mixture.
The water content must be controlled to ensure the mixture has optimal moisture, preventing it from being too fluid or too dry, thereby enhancing the forming process and the geopolymerization reaction.
   (ii) Mixing the Alkaline Activator with the Sand and Red Mud Mixture

Preparing the Alkaline Activator Solution:
If required, the alkaline activator is dissolved in water before being mixed with the sand and red mud.
The amount of activator is adjusted based on the natural alkalinity of the red mud.

Mixing the Ingredients:
The activating solution is gradually sprayed or poured into the finely ground sand and red mud mixture, while a specialized mixer ensures even distribution of all components.
The mixing process must ensure homogeneity, with all raw material particles being fully coated with the alkaline solution.

Controlling the Mixture's Moisture:
The mixture must have sufficient moisture for the geopolymerization reaction but should not be too fluid, allowing for easier forming and ensuring the mechanical properties of the final product.
   (iii) Forming the Geopolymer Mortar

Shaping Methods:
After mixing, the geopolymer mixture is molded into desired concrete components.
Possible shaping methods include:
   Casting (for fixed-shape components).
   Hydraulic pressing (to create dense, high-strength components).
   Extrusion (for fixed cross-section elements, such as bricks and pipes).
   Rolling or vibro-compaction (to improve mold filling and material density).
   Centrifugal casting (for hollow pipes or cylindrical structures).

Compression and Vibration:
Applying pressure during forming reduces porosity, increases material bonding, and improves the compressive strength of the geopolymer concrete.
Vibration can be applied during pressing to help evenly distribute the material and reduce voids in the final product.

### (iv) Hardening Through Heat Treatment at 60 °C to 250 °C

Curing Process:
After forming, the geopolymer concrete components are dried or autoclaved to activate and complete the geopolymerization reaction.
The curing temperature ranges from 60 °C to 250 °C, depending on the desired reaction speed.

Final Product Inspection:
Once dried, the product is gradually cooled to ambient temperature and subjected to quality testing before distribution.
Testing parameters include:
   Compressive strength.
   Flexural strength.
   Water impermeability.
   Chemical resistance.

### 2. Modified Production Method for Cast Geopolymer Concrete with Increased Water Content

### (i) Adjusting Water Content for Casting Applications

In certain cases, especially when using traditional casting methods, an increase in water content is necessary to improve fluidity.
The water content can be increased up to 60% by weight, instead of the 30% limit in the original method.
Higher water content improves mold filling, reduces voids, and enhances surface smoothness.

### (ii) Setting and Mold Removal Process

After pouring into molds, the mixture undergoes initial setting under normal environmental conditions, similar to traditional concrete.
Once the mixture achieves sufficient mechanical stability, the mold can be removed to proceed with heat treatment.
   (iii) Stepwise Moisture Reduction

### Step 1—Initial Drying at 80 °C

After mold removal, the product is dried at 60 °C to 80 °C to reduce moisture content below 30%.
This eliminates excess water without cracking the material structure.
At this stage, geopolymerization has begun but is not yet complete.

### Step 2—Final Curing at 250 °C

Once the moisture content drops below 30%, further heating is applied up to 250 °C to complete the geopolymerization reaction.
This process enhances strength, reduces porosity, and finalizes the microstructure of the geopolymer concrete.

### 3. Alternative Production Method for High-Amorphous Silica Sand Without Grinding

### (i) Characteristics of High-Amorphous Silica Sand

Amorphous silica (SiO₂) is the non-crystalline form of silicon dioxide, which has higher chemical reactivity than crystalline silica (quartz).
Certain natural sands have high amorphous silica content, allowing them to react effectively with alkaline activators without the need for fine grinding.
Examples of high-amorphous silica sands include:
   Volcanic sand.
   Pumice sand (volcanic ash-derived sand).
   Lateritic sand (found in tropical regions).
   Weathered silicate sand.

### (ii) Application in Geopolymer Concrete Production

### 1. Raw Material Preparation

‘Unprocessed natural sand with high amorphous silica content may have a particle size larger than 200 microns.
Due to its high reactivity, this sand can participate in geopolymerization without grinding.
Other ingredients (red mud, alkaline activators, water) remain unchanged from the original method.

### 2. Production Process Without Fine Grinding

Mixing sand with red mud and alkaline activator solution to create geopolymer mortar.
Shaping via casting, hydraulic pressing, extrusion, centrifugal molding, vibration, or vibro-compaction.
Curing at 60 °C to 250 °C to trigger the geopolymerization reaction.
   (iii) Advantages of This Method
Eliminates the fine grinding step, reducing energy consumption and production costs.
Utilizes high-amorphous silica sand, decreasing river sand mining and construction sand shortages.
Optimizes geopolymerization, achieving high strength without additional processing.

### 4. In some embodiments, finely ground sand may be replaced with finely crushed stone.

### (i) Characteristics of Finely Crushed Stone

Finely crushed stone is obtained by crushing natural rocks such as basalt, granite, limestone, dolomite, etc., to produce a fine aggregate substitute for sand.
Certain silica-rich crushed stones can participate in geopolymerization reactions similarly to finely ground sand.
Using finely crushed stone instead of sand helps reduce natural sand mining, contributing to environmental protection.

### (ii) Application in Geopolymer Concrete Production

### 1. Raw Material Preparation

Finely crushed stone replaces all or part of the finely ground sand, with a particle size of less than 200 microns.
Other components (red mud, alkaline activators, water) remain unchanged from Claim 1.

### 2. Production Process

Mixing finely crushed stone with red mud and an alkaline solution to form geopolymer mortar.
Shaping via casting, hydraulic pressing, extrusion, centrifugal molding, vibration, or vibro-compaction.
Curing at 60 °C to 250 °C to activate the geopolymerization reaction.
   (iii) Advantages of This Method
Reduces the need for natural sand mining, utilizing available crushed stone from quarries.
Enhances the mechanical strength of geopolymer concrete, making it suitable for high-load-bearing structures.

### 5. In another variation, red mud may be replaced with finely ground bauxite ore or metakaolin to provide Al₂O₃ for the geopolymerization process.

### (i) Characteristics of Finely Ground Bauxite Ore

Bauxite ore is rich in Al₂O₃ and can be finely ground to replace red mud in geopolymer concrete.
Compared to red mud, bauxite ore has a higher alumina content (30-60%), enhancing the geopolymerization reaction efficiency.
Using finely ground bauxite ore instead of red mud can reduce the environmental impact of red mud waste disposal.

### (ii) Characteristics of Metakaolin

Metakaolin is a calcined product of kaolinite mineral (Al₂Si₂O₅(OH)₄), containing high levels of SiO₂ and Al₂O₃, exhibiting strong pozzolanic reactivity.
Higher purity than red mud and bauxite ore, contributing to a more stable geopolymer matrix.
Increases compressive strength, reduces water permeability, making geopolymer concrete suitable for marine structures, transportation infrastructure, and high-load environments.
Improves thermal resistance, enhancing the fire resistance of geopolymer concrete.
   (iii) Application in Geopolymer Concrete Production

### 1. Raw Material Preparation

Red mud is replaced with finely ground bauxite ore or metakaolin, in an amount ranging from 5% to 50% by weight.
Other components (finely ground sand or crushed stone, alkaline activators, and water) remain unchanged from Claim 1.

### 2. Production Process

Mixing finely ground sand (or crushed stone) with bauxite ore/metakaolin and alkaline solution to form geopolymer mortar.
Shaping through casting, hydraulic pressing, extrusion, centrifugal casting, vibration, or vibro-compaction.
Curing at 60 °C to 250 °C to activate the geopolymerization process.
   (iii) Advantages of This Method
Enhances mechanical strength and heat resistance of geopolymer concrete.
Utilizes alternative raw materials, reducing dependence on red mud and expanding the versatility of geopolymer applications.
Broadens the scope of geopolymer concrete technology, particularly for high-load-bearing structures.

### 6. Geopolymer Mortar is Granulated Before Feeding into Forming Equipment

### (i) Characteristics of Granulated Geopolymer Mortar

In certain manufacturing processes, pre-forming geopolymer mortar into granules before molding or extrusion helps control moisture content and ensure uniformity.
Granulated geopolymer mortar can be shaped into various sizes and forms, depending on the specific forming method.
This technique is particularly beneficial for extrusion, centrifugal molding, or vibro-compaction processes, where flowability and mold filling must be precisely controlled.

### (ii) Application in Geopolymer Concrete Production

### 1. Raw Material Preparation

Mixing finely ground sand or crushed stone, red mud or finely ground bauxite, alkaline activators, and water.
Adjusting the moisture content to create a geopolymer mixture suitable for granulation.

### 2. Granulation Process

Compacting geopolymer mortar into granules, which can be:
Spherical pellets for extrusion-based production.
Compressed blocks for hydraulic pressing into fixed molds.
Small, highly flowable pellets for centrifugal or vibro-compaction processes.

### 3. Application of Granulated Geopolymer Mortar

Feeding into hydraulic presses for brick and concrete panel production.
Extruding into fixed cross-section elements such as beams and foundation piles.
Using in centrifugal molding to manufacture drainage pipes and hollow concrete columns.
Employing vibro-compaction to produce dense, high-strength geopolymer products.
   (iii) Advantages of This Method
Optimizes manufacturing efficiency, improving the homogeneity of geopolymer mortar.
Reduces material loss, enhancing overall production yield.
Increases product durability and density by better controlling particle distribution.

### 7. Finely Ground Sand is Partially Replaced with a SiO₂-Rich Aggregate Mixture

(i) Structure of Geopolymer Concrete with SiO₂-Rich Aggregates
Geopolymer concrete can incorporate a blend of finely ground sand and SiO₂-rich coarse aggregates to adjust density, strength, and mechanical properties.
Suitable SiO₂-rich coarse aggregates include:
   Crushed stone, natural gravel, basalt, granite.
   Fly ash, metakaolin, silica fume, diatomite, rice husk ash, glass powder, or recycled materials.
   Coarse sand or unground sand to regulate mixture flowability.

### (ii) Application in Geopolymer Concrete Production

Reduces production costs by utilizing locally available aggregates.
Increases concrete strength using high-durability materials such as basalt or granite.
Adjusts aggregate composition according to specific structural requirements.
   (iii) Advantages of This Method
Flexibility in raw material selection, optimizing production costs.
Enhances mechanical performance, making it suitable for high-load structures.
Reduces natural sand extraction, replacing it with crushed stone or recycled materials.

### 8. Geopolymer Mortar is Preheated at 60 °C to 150 °C. Before Forming

### (i) Purpose of Preheating

Preheating accelerates the geopolymerization reaction, improving the adhesion and consistency of the mixture before forming.
Reduces setting time, enhancing shape stability.
Minimizes shrinkage and surface cracking during post-forming curing.

### (ii) Preheating Process

After mixing, geopolymer mortar is preheated before forming, with temperature levels adjusted as follows:
   60 °C-80 °C: Mild activation, suitable for casting methods.
   80 °C-120 °C: Faster activation, ideal for hydraulic pressing and vibro-compaction.
   120 °C-150 °C: Higher viscosity, optimal for extrusion and granulation processes.
      (iii) Applications of This Method
Improves workability of geopolymer mortar before pressing or casting.
Reduces curing time, speeding up production cycles.
Enhances initial strength, facilitating transportation and installation.

### (iv) Advantages of This Method

Shortens production cycles, ensuring faster strength development.
Reduces shrinkage, extending product lifespan.
Enhances surface quality, minimizing cracks and defects.

### 9. Where Drying is Performed Using Various Heating Methods

### (i) Role of Drying in Geopolymerization

Drying is a critical step in finalizing the geopolymerization reaction, removing excess moisture, and enhancing the mechanical strength of the product.
Depending on production conditions, various drying methods can be applied to optimize efficiency and cost-effectiveness.

### (ii) Drying Methods Applied

Resistive Heating Oven: Uses resistive elements for heating, suitable for small or complex-shaped products.
Gas-Fired Oven: More energy-efficient than resistive heating, ideal for large-scale production.
Infrared Oven: Provides uniform heating, reducing drying time.
Vacuum Drying Oven: Minimizes rapid moisture loss, preventing surface cracks.
Autoclave Drying (High-Pressure Steam Curing): Produces higher-strength materials, suitable for heavy-load applications.
Convection Heating Oven: Uses hot air circulation for faster drying.
Solar Drying: Eco-friendly solution, reducing operational costs.
Microwave Drying: Rapid drying, saving time and energy.
   (iii) Advantages of This Method
Flexible selection of drying technology, tailored to different production scales.
Shortens production time, accelerating the geopolymerization reaction.
Optimizes cost efficiency, reducing energy consumption.

### 10. Steel Reinforcement is Used in Geopolymer Concrete Similar to Portland Cement Concrete

### (i) Application of Steel Reinforcement in Geopolymer Concrete

Similar to Portland cement concrete, geopolymer concrete can be reinforced with steel to enhance load-bearing capacity.
Reinforcement types may include:
Rebar, steel fibers, or steel mesh.
Basalt fiber, carbon fiber, or glass fiber (for corrosion-resistant applications).
   (ii) Methods of Incorporating Reinforcement into Geopolymer Concrete
Traditional Reinforced Concrete: Rebar is placed inside molds before pouring geopolymer mixture.
Fiber-Reinforced Geopolymer Concrete: Steel or basalt fibers can be directly mixed into the geopolymer mortar to improve tensile strength.
Corrosion Protection Coatings: Geopolymer coatings can be applied to protect rebar from chloride attacks.
   (iii) Advantages of This Method
Enhances load-bearing capacity, expanding the applications of geopolymer concrete in large-scale projects.
Superior corrosion resistance compared to Portland cement, particularly in marine environments.
Utilizes existing steel reinforcement technology, eliminating the need for construction modifications.

### 11. Geopolymer Mortar is Mixed with Additives for Performance Enhancement

### (i) Types of Additives Used

Plasticizers: Improve workability, enhancing flowability.
Waterproofing Agents: Increase water resistance, ideal for outdoor structures.
Strength Enhancers: Improve early and ultimate strength development.
Reinforcing Fibers: Carbon fiber, glass fiber, or basalt fiber to improve tensile strength.

### (ii) Application in Geopolymer Concrete Production

Adjusting mix composition to suit specific construction needs.
Enhancing durability, crack resistance, and chemical resistance.
   (iii) Advantages of This Method
Increases concrete lifespan, reducing maintenance costs.
Enhances structural performance, expanding its application scope.
Improves surface quality, producing aesthetically refined products.

### 12. Zeolite is Added to Improve Mechanical Properties and CO₂ Absorption

### (i) Role of Zeolite in Geopolymer Concrete

Zeolite is an aluminosilicate mineral with a porous structure, enhancing CO₂ absorption in geopolymer concrete.
When added to geopolymer mixtures, zeolite:
   Increases mechanical strength, particularly compressive and flexural strength.
   Enhances water resistance, improving durability in humid environments.
   Traps greenhouse gases (CO₂), supporting sustainable development.

### (ii) Application of Zeolite in Geopolymer Concrete Production

### 1. Raw Material Preparation

Zeolite is finely ground and incorporated at up to 20% by weight of the geopolymer mixture.
Zeolite may replace a portion of finely ground sand or red mud, adjusting activation properties.

### 2. Production Process

Mixing zeolite with sand, red mud, and alkaline activators to form geopolymer mortar.
Shaping via casting, hydraulic pressing, extrusion, centrifugal molding, vibration, or vibro-compaction.
Curing at 60 °C to 250 °C to complete geopolymerization.
   (iii) Advantages of This Method
Enhances strength and reduces environmental impact through CO₂ absorption.
Improves insulation and acoustic properties of geopolymer concrete.
Enhances chemical resistance, increasing durability in harsh environments.

### 13. Barium Sulfate (BaSO₄) is Added to Enhance Radiation Shielding Properties

### (i) Role of Barium Sulfate in Geopolymer Concrete

Barium Sulfate (BaSO₄) is a high-density material with excellent radiation absorption capabilities, shielding structures from ionizing radiation.
When added to geopolymer mixtures, BaSO₄:
   Shields against gamma rays and X-rays, ideal for medical and nuclear applications.
   Increases mechanical strength, particularly compressive strength and load-bearing capacity.
   Reduces water permeability, enhancing service life in extreme environments.

### (ii) Application of BaSO₄ in Geopolymer Concrete Production

### 1. Raw Material Preparation

BaSO₄ is finely ground and incorporated at up to 15% by weight.
BaSO₄ may replace a portion of finely ground sand or red mud, increasing material density.

### 2. Production Process

Mixing BaSO₄ with sand, red mud, and alkaline activators to form geopolymer mortar.
Shaping via casting, hydraulic pressing, extrusion, centrifugal molding, vibration, or vibro-compaction.
Curing at 60 °C to 250 °C to complete geopolymerization.
   (iii) Advantages of This Method
Enhances radiation protection, suitable for nuclear safety structures.
Improves strength and load-bearing properties of geopolymer concrete.
Increases longevity and impermeability, protecting structures in harsh environments.

### 14. Potential Applications of Geopolymer Concrete Products

### (i) Expanded Applications for Geopolymer Concrete

This geopolymer concrete can replace Portland cement concrete in various construction applications, including:
   Residential and high-rise buildings.
   Foundations, beams, columns, floors, wall panels.
   Precast components such as bricks, tiles, pavers, drainage pipes.
   Infrastructure projects, including bridges, roads, and barriers.
   Heavy-load industrial structures, including cold storage and containment facilities.
   Marine and offshore structures, corrosion-resistant applications.
   Fire-resistant, radiation-shielding, and chemically resistant components.
   3D-printed geopolymer concrete for custom-built structures.

### (ii) Advantages of This Method

Directly replaces Portland cement concrete, reducing CO₂ emissions in construction.
Utilizes sustainable raw materials, reducing reliance on natural resource extraction.
Expands the scope of geopolymer concrete applications, beyond traditional uses.

### EXAMPLES

### Example 1: Production of Geopolymer Concrete from Finely Ground Sand and Red Mud

### Experimental Description

A batch of geopolymer concrete was produced using the following composition:
Finely ground desert sand: 70% by weight
Red mud: 25% by weight
Alkaline activator (8M NaOH+Na₂SiO₃ in a 1:2 ratio): 5% by weight
Water: 15% by weight

### Procedure

1. Dry mixing: Finely ground sand and red mud were uniformly mixed for 5 minutes.
2. Alkaline solution preparation: NaOH and Na₂SiO₃ were dissolved in water.
3. Geopolymer mortar preparation: The alkaline solution was gradually added to the dry mixture and stirred for 10 minutes.
4. Molding: The geopolymer mortar was poured into 100×100×100 mm cubic molds.
5. Curing:
   a. Dried at 80 °C for 24 hours to reduce moisture content below 10%.
   b. Further heated at 200 °C for 2 hours to complete the geopolymerization reaction.
6. Strength testing: After 7 days, the compressive strength reached 65 MPa.

### Results and Applications

Smooth surface, high density of the final product.
High strength, suitable for brick production and precast concrete panels.
30% reduction in CO₂ emissions compared to Portland cement concrete.

### Example 2: Application of Zeolite to Enhance Co₂ Absorption

### Experimental Description

A batch of geopolymer concrete was produced with the following composition:
Finely ground sand: 65% by weight
Red mud: 20% by weight
Finely ground zeolite: 10% by weight
Alkaline activator (10M NaOH+Na₂SiO₃ in a 1:1 ratio): 5% by weight
Water: 18% by weight

### Procedure

1. Dry mixing: Finely ground sand, red mud, and zeolite were thoroughly mixed.
2. Preparation of alkaline activator solution, which was then evenly mixed with the dry mixture.
3. Molding: The geopolymer mortar was poured into cylindrical molds (50×100 mm).
4. Curing:
   a. Heated at 80 °C for 24 hours.
   b. Further heated at 250 °C for 1 hour.
5. CO₂ absorption testing:
   a. The sample was placed in a 10% CO₂ environment for 28 days.
   b. The CO₂ absorption measured was 8.5% by weight.

### Results and Applications

Zeolite-containing geopolymer concrete enhances CO₂ absorption, helping reduce greenhouse effects.
Applicable for green construction projects.
Improved insulation and water resistance compared to samples without zeolite.

### Example 3: Application of Barium Sulfate (BaSO₄) for Radiation Shielding

### Experimental Description

A batch of geopolymer concrete containing BaSO₄ was produced using the following composition:
Finely ground sand: 55% by weight
Red mud: 20% by weight
Finely ground BaSO₄: 15% by weight
Alkaline activator (10M NaOH+Na₂SiO₃): 10% by weight
Water: 16% by weight

### Procedure

1. Mixing: Finely ground sand, red mud, and BaSO₄ were thoroughly mixed.
2. Molding: The geopolymer mortar was poured into 300×300×50 mm plate molds.
3. Curing:
   a. Heated at 60 °C for 24 hours.
   b. Further heated at 250 °C for 2 Hours.
4. Radiation shielding test:
   a. The sample was placed in a gamma radiation exposure chamber (Co-60 source).
   b. Radiation attenuation was 35% higher than conventional concrete.

### Results and Applications

BaSO₄-enhanced geopolymer concrete provides high radiation shielding, suitable for hospitals, nuclear power plants, and research laboratories.
Improved durability and chemical resistance.

### Example 4: Illustration of Increasing Water Content to 60%

### Experimental Description

A geopolymer concrete mix was prepared using the following composition (by weight percentage):
Finely ground sand (desert sand): 60%
Red mud: 30%
8M NaOH solution: 5%
Water: 50%

### Procedure

1. Dry mixing: Finely ground sand and red mud were thoroughly mixed to ensure uniform particle distribution.
2. Preparation of alkaline solution: NaOH was dissolved in water.
3. Wet mixing: The NaOH solution was gradually added to the sand-red mud mixture, stirred for 10 minutes for homogeneity.
4. Molding: The geopolymer mortar was poured into standard molds and allowed to set at room temperature for 24 hours.
5. Preliminary heating: After 24 hours, the sample was heated at 80 °C for 12 hours to reduce moisture content below 30%.
6. Final curing: The sample was further heated to 250 °C for 6 hours to complete geopolymerization.

### Results

Compressive strength of 45 MPa after 7 days.
Significant reduction in water absorption, enhancing waterproofing properties.
Chloride resistance testing showed no corrosion, making it suitable for marine and high-load structures.
Preliminary drying at 80 °C helped regulate moisture loss, preventing shrinkage and cracking.

### Industrial Applicability

Geopolymer concrete components produced using this invention have a wide range of applications in construction and related industries, including:

### Basic Building Materials

Manufacturing of concrete blocks, non-fired bricks, paving tiles, roofing tiles, and lightweight wall panels.
These products offer high strength, superior impermeability, and do not require high-temperature firing, reducing energy consumption compared to traditional clay bricks.
The natural reddish-brown color from red mud can be used to color bricks and tiles without requiring additional coatings or pigments.

### Infrastructure and Industrial Components

Production of drainage pipes, reinforced concrete pipes, traffic barriers, curbstones, seawall structures, erosion protection components, utility poles, and telecommunication towers.
Thanks to corrosion resistance, buried or outdoor components have high durability, resisting degradation in moist soil or seawater environments.
Geopolymer seawall and wave-breaking structures exhibit better durability than Portland cement concrete when exposed to marine conditions.

### Load-Bearing Structural Components

Precast foundation piles, bridge girders, floor beams, and reinforced geopolymer concrete slabs.
With high compressive strength and excellent ductility, geopolymer concrete is suitable for major load-bearing elements in construction.
Steel reinforcement in geopolymer concrete is better protected against corrosion due to the stable alkaline environment, reducing steel degradation over time.

### Heat-Resistant, Soundproof, and Insulating Materials

Fireproof wall panels, thermal insulation panels, and fire-resistant bricks for industrial buildings and warehouses.
Geopolymer materials withstand high temperatures, ensuring structural integrity in fire hazards, unlike traditional concrete, which cracks and explodes due to moisture evaporation under high heat.
Geopolymer-based water filtration and environmental treatment components can be used for:
   Heavy metal removal from contaminated water.
   Air purification by adsorbing toxic gases like SO₂ and H₂S in industrial emissions.

Thus, geopolymer concrete using finely ground sand and red mud can be applied to both conventional construction and specialized structural components, maximizing the advantages of this innovative material.

### Economic and Environmental Benefits

### 1. Industrial Waste Management and Environmental Protection

The most significant benefit is the utilization of large amounts of red mud, a hazardous industrial byproduct.
Instead of incurring high costs for landfill disposal, this invention recycles red mud into construction materials, reducing soil and groundwater contamination risks.
Using finely ground sand reduces river sand mining, helping protect riverbeds and ecosystems, mitigating erosion and sediment loss.
This technology minimizes waste, promotes resource recycling, and supports the circular economy model in industrial production.

### 2. Low Carbon Emissions and Energy Efficiency

No clinker production required, avoiding the high-temperature process (~1450 °C) of traditional cement manufacturing.
The lower curing temperature (~200 °C) results in significant energy savings.
If waste heat from industrial processes or renewable energy is used for curing, the carbon footprint is further minimized.
The semi-dry pressing method reduces water consumption, eliminating the need for continuous water curing, and prevents wastewater discharge during production.

### 3. Cost-Effective Production

Red mud and finely ground sand are low-cost or even free, with industries willing to pay for red mud disposal.
Compared to purchasing cement or traditional waste disposal methods, manufacturers save significantly.
The semi-dry pressing process with vibration compaction enables faster production cycles, reducing inventory and storage costs.
The durability of the final product minimizes maintenance costs, benefiting investors by reducing long-term operational expenses.
Companies adopting green technology can qualify for:
   Government incentives (green certification, carbon credits, R&D support).
   Enhanced brand reputation in the sustainable construction market.

### 4. Sustainable Development and Societal Benefits

This technology addresses the long-standing red mud disposal issue in bauxite mining regions, benefiting local communities and environmental stability.
Encourages innovation in local building material industries, reducing dependency on imported cement and long-distance raw material transportation.
Converting industrial waste into valuable resources creates a positive ripple effect, motivating other industries to explore cleaner production solutions.

### Conclusion

The geopolymer concrete invention using finely ground sand and red mud presents a comprehensive solution by producing high-performance construction materials, solving environmental challenges, and delivering economic advantages.

This method is not only technically significant but also strategically aligned with sustainable development and eco-friendly trends in modern construction.

1. A method for producing geopolymer concrete from natural sand (including desert sand, sea sand, river sand, and mined sand) and red mud, comprising the steps of: Preparing raw materials, including: Finely ground natural sand with a particle size of ≤200 microns, in an amount ranging from 50% to 95% by weight. Red mud, in an amount ranging from 5% to 50% by weight. Alkaline activator (NaOH, KOH, Na₂SiO₃, K₂SiO₃, Ca(OH)₂, liquid glass, or their mixtures), added only if the alkalinity of red mud is insufficient to trigger geopolymerization, in an amount ranging from 0% to 20% by weight. Water, in an amount ranging from 5% to 30% by weight of the total mixture. Mixing the alkaline activator with water to form an activation solution (if needed), then thoroughly mixing with the sand and red mud to form geopolymer mortar. Shaping the geopolymer mortar by casting or pressing under pressure in molds to achieve the desired size and shape, wherein the shaping method may include hydraulic pressing, extrusion, rolling, centrifugal casting, vibration, or vibro-compaction. Hardening the material by drying at temperatures ranging from 60 °C to 250 °C to obtain geopolymer concrete.

2. The method according to claim 1, wherein the water content is increased up to 60% for conventional casting, followed by setting and demolding. The product undergoes staged heating, including: a) Pre-heating at 80 °C to reduce moisture below 30%. b) Further heating up to 250 °C to complete the geopolymerization process.

3. The method according to claim 1, wherein finely ground sand may be omitted if the natural sand used contains high amorphous silica content.

4. The method according to claim 1, wherein finely ground sand is replaced with finely crushed stone.

5. The method according to claim 1, wherein red mud is replaced with finely ground bauxite ore or metakaolin to provide Al₂O₃ for the geopolymerization process.

6. The method according to claim 1, wherein geopolymer mortar is granulated into pellets for easier feeding into forming equipment, including hydraulic presses, extruders, rolling mills, centrifugal casting machines, vibration tables, or vibro-compaction systems.

7. The method according to claim 1, wherein finely ground sand is replaced with a mixture of finely ground sand and aggregates selected from SiO₂-rich materials, including: sand, crushed stone, gravel, fly ash, metakaolin, silica fume, diatomite, rice husk ash, glass powder, or recycled materials.

8. The method according to claim 1, wherein geopolymer mortar is preheated at temperatures ranging from 60 °C to 150 °C before being poured into molds or fed into forming equipment, including hydraulic presses, extruders, rolling mills, centrifugal casting machines, vibration tables, or vibro-compaction systems.

9. The method according to claim 1, wherein the drying process can be performed using:
a) Resistive heating ovens. b) Gas-fired ovens. c) Infrared heating ovens. d) Vacuum drying ovens. e) Autoclave curing (high-pressure steam curing). f) Convection heating ovens. g) Solar drying systems. h) Microwave drying.

10. The method according to claim 1, wherein steel reinforcement is incorporated into geopolymer concrete structures in a manner similar to Portland cement-based reinforced concrete.

11. The method according to claim 1, wherein geopolymer mortar is mixed with performance-enhancing additives, including: plasticizers, waterproofing agents, strength enhancers, or fiber reinforcements.

12. The method according to claim 1, wherein zeolite is incorporated at up to 20% by weight to enhance mechanical properties and CO₂ absorption capabilities of geopolymer concrete components.

13. The method according to claim 1, wherein Barium Sulfate (BaSO₄) is incorporated at up to 15% by weight to enhance radiation shielding properties of geopolymer concrete, making it suitable for high-radiation environments such as nuclear facilities and medical radiation shielding structures.

14. The geopolymer concrete produced by the method in claim 1, wherein the final product can be used as a substitute for traditional Portland cement concrete in various applications.
